(19) United States
(12) Patent Application Publication
(10) Pub. No.: US 2024/0135345 A1
(43) Pub. Date: Apr. 25, 2024

(54) PLATOONING ASSISTANCE DEVICE, PLATOONING ASSISTANCE METHOD, AND PROGRAM

(71) Applicant: ISUZU MOTORS LIMITED, Yokohama-shi (JP)

(72) Inventors: Tomoaki SHIMOZAWA, Fujisawa-shi (JP); Maya MATSUSHITA, Fujisawa-shi (JP); Yuka MIZUSHI, Fujisawa-shi (JP); Atsushi SHITANAKA, Fujisawa-shi (JP)

(21) Appl. No.: 18/277,222

(22) PCT Filed: Mar. 21, 2022
(86) PCT No.: PCT/JP2022/012962

§ 371 Date: Aug. 13, 2023

(30) Foreign Application Priority Data
Mar. 21, 2021 (JP) 2021-047195

(51) Int. Cl. G06Q 20/10; G05D 1/644; G05D 1/69; G05D 109/10; G05D 111/30

(52) U.S. Cl. CPC G06Q 20/102; G05D 1/644; G05D 1/69; G05D 2109/10; G05D 2111/32; G06Q 2220/00

(57) ABSTRACT

A platooning assistance device and a program with which it is possible to distribute the effect of platooning, and make payment. The platooning assistance device lets each of a plurality of vehicles forming a platoon have: a transaction data generation unit that generates platoon identification information identifying the platoon, vehicle identification information identifying the vehicle, and fuel consumption of the vehicle during platooning as transaction data; and a communication unit that transmits the generated transaction data to a network, and receives, from the network, data is the transaction data of each of the plurality of vehicles, and approved by a blockchain function. Any one of the plurality of vehicles has: a storage unit that stores smart contract data having a programmed, process for distributing the effect of platooning and making payment; and an execution unit that executes the process, on the basis of the approved data, in the blockchain.

### TECHNICAL FIELD

The present disclosure relates to a platooning assistance device, as platooning assistance method and a program.

### BACKGROUND ART

For example, in platooning of three or more vehicles equipped with an internal combustion engine (engine) as the power source, the fuel consumption reduction effects of the leading vehicle and the last vehicle are unequally lower than that of the intermediate vehicle. In view of this, it is desirable to equally provide the fuel consumption effect of the platooning to the plurality of vehicles making up a platoon.

For example, PTL 1 discloses a platooning assistance system including a cellular communication network configured to perform communication between a server and an in-vehicle terminal by accessing a network through a communication line, a means for acquiring vehicle information as information relating to vehicles that can form the platooning, a means for making up a platoon including a plurality of vehicles, a means for calculating the effect of platooning on the basis of the vehicle information for each vehicle making up the platoon, and a means for generating distribution data that is data for distributing the effect to the plurality of vehicles making up the platoon.

### CITATION LIST

### Patent Literature

### PTL 1

Japanese Patent Application Laid-Open No. 2018-181142

### SUMMARY OF INVENTION

### Technical Problem

In the platooning assistance system disclosed in PTL 1, however, it is disadvantageously difficult to distribute the effect of platooning and make a payment because it entails a high equipment cost of the communication environment for the communication between the server and the in-vehicle terminal, and a high maintenance cost for the server.

An object of the present disclosure is to provide a platooning assistance device, a platooning assistance method and a program that can distribute the effect of platooning and make a payment.

### Solution to Problem

To achieve the above-described object, in a platooning assistance device according to the present disclosure, each of a plurality of vehicles making up a platoon includes: a transaction data generation section configured to generate, as transaction data, platoon identification information for identifying the platoon, vehicle identification information for identifying the vehicle, and a fuel consumption amount of a platooning vehicle, and a communication section configured to transmit, to a network, the transaction data generated, and receive, from the network, the transaction data of each of the plurality of vehicles that is approved by a function of a blockchain. One of the plurality of vehicles includes: a storage section configured to store smart contract data in which a predetermined process of distributing an effect of platooning and making a payment is programed, and an execution section configured to execute the predetermined process based on the approved data in the blockchain.

In a platooning assistance method according to the present disclosure, a terminal of each of a plurality of vehicles making up a platoon generates, as transaction data, platoon identification information for identifying the platoon, vehicle identification information for identifying the vehicle, and a fuel consumption amount of a platooning vehicle, and transmits, to a network, the transaction data generated, and receives, from the network, the transaction data of each of the plurality of vehicles that is approved by a function of a blockchain. The terminal of one of the plurality of vehicles stores smart contract data in which a predetermined process of distributing an effect of platooning and making a payment is programed, and executes the predetermined process based on the approved data in the blockchain.

A program according to the present disclosure program is configured to cause a computer of each of a plurality of vehicles making up a platoon to perform a process of generating, as transaction data, platoon identification information for identifying the platoon, vehicle identification information for identifying the vehicle, and a fuel consumption amount of a platooning vehicle, transmitting, to a network, the transaction data generated, and receiving, from the network, the transaction data of each of the plurality of vehicles that is approved by a function of a blockchain, the program being configured to cause the computer of one of the plurality of vehicles to execute a process of distributing an effect of platooning and making a payment based on the approved data in the blockchain.

### Advantageous Effects of Invention

According to the present disclosure, it is possible to distribute the effect of platooning and make a payment.

### BRIEF DESCRIPTION OF DRAWINGS

FIG. 1 is a diagram illustrating a configuration of a platooning assistance device according to an embodiment of the present disclosure;

FIG. 2 is a flowchart illustrating an operation of the platooning assistance device according to the embodiment; and

FIG. 3 is a flowchart illustrating an operation of a platooning assistance device according to a modification of the embodiment.

### DESCRIPTION OF EMBODIMENTS

A platooning assistance device of an embodiment of the present disclosure is described below with reference to the accompanying drawings. In the platooning assistance device according to the present disclosure, terminals (nodes) mounted in a plurality of vehicles making up a platoon are connected to a network. In the present embodiment, a blockchain network where blockchain is distributed is used as an example of the network.

A blockchain is data in which a plurality of blocks is connected in a chain form. Each of the plurality of blocks stores one or more transaction data.

As an example of a blockchain, there is a blockchain used for exchanging data of electronic cryptocurrency such as Bitcoin (registered trademark). A blockchain contains a hash of the immediately preceding block.

The hash of the immediately preceding block is the information used to determine whether it is a correct block that is correctly linked from the immediately preceding block. If the transaction data stored in the preceding block has been tampered with, the hash of the immediately preceding block in any of the blocks in the blockchain will be inconsistent, and thus the fact that it has been tampered with will become apparent.

When new transaction data is generated, the terminal (node) with the earliest successful verification and approval among the terminals (nodes) connected to the blockchain network adds the new block to the blockchain. Here, in Bitcoin (registered trademark), for example, the verification and approval are a process called “mining”. The terminal that performs verification and approval may also be referred to as an “approval terminal” or “mining device”. The blockchain after the addition of the new block is transmitted to each of the terminals through the blockchain network. In this manner, each of the terminals (nodes) shares the blockchain after the addition. In the following description, the verification and approval of new transaction data and the addition of new block to the blockchain are referred to as “the function of the blockchain”.

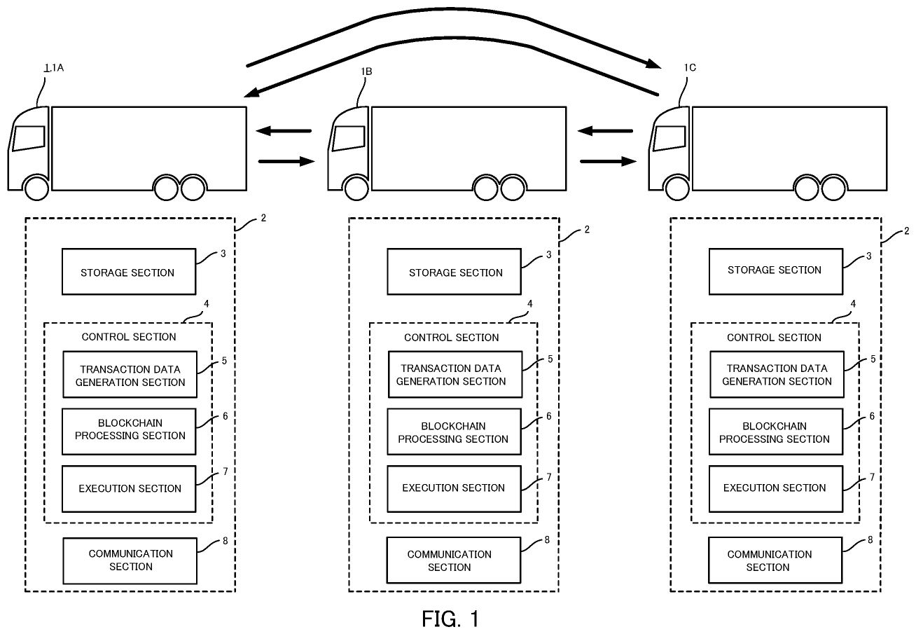

Next, with reference to FIG. 1, a configuration of the platooning assistance device according to the present embodiment is described. As illustrated in FIG. 1, in a platoon composed of three vehicles 1 equipped with an internal combustion engine (engine) as the power source, intermediate vehicle 1B achieves the highest fuel consumption improvement effect. On the other hand, leading vehicle 1A has the lowest fuel consumption improvement effect because it receives the largest air resistance among the three vehicles 1. In addition, the fuel consumption improvement effect is also an emission amount reduction effect for reducing the CO2 emission amount. In the following description, the fuel consumption improvement effect and the emission amount reduction effect are referred to as “effect of platooning” or “effect”.

The platooning assistance device of the present embodiment equally distributes the effect of platooning among a plurality of vehicles 1 making up a platoon and performs payment. Each of the plurality of vehicles 1 is equipped with terminal 2 (node). The plurality of vehicles 1 (terminal 2) are mutually connected to a blockchain network. Note that in the present embodiment, a plurality of terminals 2 have the same function, but it suffices that at least one of the plurality of vehicles 1 has the function of executing a predetermined process of distributing the effect of platooning and making a payment in the blockchain, and the like.

Note that the description of the present embodiment is based on the assumption that terminal 2 is mounted in vehicle 1, but the present disclosure is not limited to this, and, for example, it suffices to adopt a terminal that is associated with vehicle 1 and is connectable to a blockchain network regardless of whether it is mounted in vehicle 1.

In addition, while FIG. 1 illustrates three terminals 2 connected to a blockchain network, any number of terminals 2 may be connected to the blockchain network in accordance with the number of vehicles 1 making up a platoon. In addition, it is possible to adopt any methods for the connection to the blockchain network. For example, terminal 2 may be connected to the blockchain network through wired communication of any type or through radio communication of any type.

Next, a functional configuration of terminal 2 according to the present embodiment is described. Terminal 2 according to the present embodiment includes storage section 3, control section 4, and communication section 8.

### Storage Section 3

Storage section 3 stores data of the consumption amount (actual value) of the fuel jetted to the cylinder of the engine of platooning vehicle 1. Control section 4 performs summation of the fuel consumption amount of platooning vehicle 1, and stores the sum of the fuel consumption amount in storage section 3. In this manner, storage section 3 stores the latest fuel consumption amount of platooning vehicle 1. Note that the fuel consumption amount can be calculated by multiplying the injector valve opening time (energization time of the valve drive coil) by the injector discharge rate per unit time.

In addition, storage section 3 stores reference data that is referred to for estimation of the fuel consumption amount (estimation value) of vehicle 1 in a non-platooning case. Examples of the reference data include vehicle specifications, engine data, transmission data, full-load torques, friction torques, and fuel consumption maps. Here, the fuel consumption map is a map representing a relationship between the fuel consumption amount and a combination of the torque and the rotational frequency of the engine. Note that the fuel consumption amount (actual value) of leading vehicle 1A may be used instead as the fuel consumption amount (estimation value) of vehicle 1 in a non-platooning case.

In addition, storage section 3 stores a vehicle ID, which is identification information (ID: identifier) for identifying vehicle 1, and a platoon ID, which is identification information for identifying the platoon. In addition, storage section 3 stores smart contract data. Here, the smart contract data is data in which a predetermined process of distributing the effect of platooning and making a payment is programed.

Control section 4 includes transaction data generation section 5, blockchain processing section 6, and execution section 7.

### Transaction Data Generation Section 5

Transaction data generation section 5 generates data of each of the vehicle ID, the platoon ID, and the fuel consumption amount (actual value) of vehicle 1, as transaction data. Communication section 8 transmits the generated transaction data to the blockchain network. In addition, communication section 8 receives the transaction data of each of the plurality of vehicles 1 from the blockchain network.

### Blockchain Processing Section 6

Blockchain processing section 6 executes the function of the blockchain. More specifically, blockchain processing section 6 performs verification and approval of the transaction data received by communication section 8. Then, blockchain processing section 6 that has successfully performed the verification and approval at the earliest timing among blockchain processing sections 6 of the plurality of terminals 2 adds a new block to the blockchain. Communication section 8 transmits, to the blockchain network, the blockchain to which the new block has been added. In this manner, each terminal 2 can share the blockchain to which the block has been added. In the following description, the transaction data verified and approved by the function of the blockchain is referred to as “approved data” or “approval data”.

### Approval Terminal

In the case where an approval terminal (mining device) (not illustrated in the drawing) is connected to the blockchain network in addition to each terminal 2, it is possible to adopt a configuration in which the transaction data is verified and approved through execution of the function of the blockchain by the approval terminal so as to add a new block to the blockchain and transmit, to the blockchain network, the blockchain after the addition, for example. In this manner, each terminal 2 can share the blockchain after the addition of the block.

In the shared blockchain after the addition, the approval data related to the fuel consumption amount of each of the plurality of vehicles 1 in a platooning state is added.

### Execution Section 7

Execution section 7 executes a predetermined process in the blockchain on the basis of the approval data. For example, when the platooning is completed, control section 4 instructs execution section 7 to execute the predetermined process. Execution section 7 executes the predetermined process on the basis of the instruction from control section 4. While a configuration in which a predetermined process is executed when the platooning is completed is described here, the present disclosure is not limited to this, and a predetermined process may be executed at a predetermined time interval during a platooning, or, a predetermined process may be executed on a predetermined date (payment date). In this case, the predetermined date (payment date) is stored in storage section 3.

Execution section 7 outputs data that has been subjected to payment (payment data) by executing a predetermined process in the blockchain. Communication section 8 transmits the payment data to the blockchain network. Communication section 8 of each terminal 2 receives the approved payment data (for example, the payment data approved by the approval terminal) from the blockchain network.

Next, a specific example of the effect of platooning is described. The effect of platooning is the gain corresponding to the difference between the fuel consumption amount (actual value) of the plurality of vehicles 1 and the average value of the fuel consumption amounts (actual values), for example. In the case where the fuel consumption amount (actual value) is 100 liters and the average value of the fuel consumption amounts (actual values) is 90 liters, it is the gain corresponding to 10 liters as their difference. The gain can be calculated by multiplying the difference (10 liters) by the unit price (the fuel amount per one liter).

In addition, the effect of platooning may be the gain corresponding to the difference between the fuel consumption amount (actual value) of each of the plurality of vehicles 1 and the estimation value of the fuel consumption amount of vehicle 1 estimated in a non-platooning case, for example. In the case where the fuel consumption amount (actual value) is 100 liters and the fuel consumption amount (estimation value) is 110 liters, it is the gain corresponding to 10 liters as their difference. Likewise, the gain can be calculated by multiplying the difference (10 liters) by the unit price (the fuel amount per one liter).

Communication section 8 transmits the gain calculated by execution section 7 to the blockchain network as the payment data. Communication section 8 of each terminal 2 receives the payment data approved by the blockchain network. The payment data is output to the user interface provided in each terminal 2. The user interface provided in each vehicle 1 is not limited. For example, it is possible to adopt a configuration in which each vehicle 1 includes a display, and a notification of the effect of platooning (gain) is provided to the user by displaying the payment data on the display.

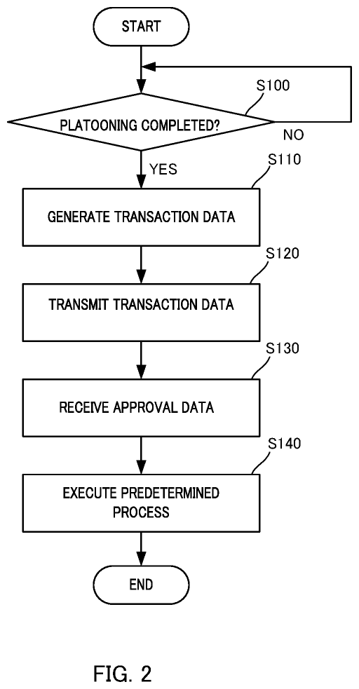

Next, an operation of the platooning assistance device according to the present embodiment is described with reference to FIG. 2. FIG. 2 is a flowchart illustrating an operation of the platooning assistance device according to the present embodiment. In the description of the operation of the platooning assistance device with reference to FIG. 2, it is assumed that the latest fuel consumption amount of platooning vehicle 1 is stored in storage section 3. In addition, storage section 3 stores smart contract data in which a predetermined process of distributing the effect of platooning and making a payment is programed. Note that the above-described condition is merely an example, and may be changed as necessary.

First, at step S100 in FIG. 2, control section 4 determines whether the platooning has been completed. When the platooning has been completed (step S100: YES), the process is advanced to step S110. When the platooning has not been completed (step S100: NO), the process returns to the state before step S100.

Next, at step S110, transaction data generation section 5 generates the vehicle ID, the platoon ID and the fuel consumption amount of platooning vehicle 1, as transaction data.

Next, at step S120, communication section 8 transmits the generated transaction data to the blockchain network.

Next, at step S130, communication section 8 receives the approval data from the blockchain network.

Next, at step S140, execution section 7 executes a predetermined process in the blockchain on the basis of the approval data. Thereafter, the procedure illustrated in FIG. 2 is completed. An example of the operation of the platooning assistance device is as described above.

In addition, each step in the operation of the platooning assistance device according to the present embodiment is not necessarily processed in the order illustrated in the flowchart. Specifically, the steps in the operation of the device may be processed in an order different from the order described as the flowchart, or may be processed in parallel.

Next, a hardware configuration of platooning assistance device is described. As terminal 2 illustrated in FIG. 1, it is possible to use a general-purpose computer system including a central processing unit (CPU), a memory, a storage (HDD: hard disk drive, SSD: solid state drive), a communication device, an input device, and an output device, for example. In this computer system, each function of terminal 2 is achieved when the CPU executes a predetermined program loaded on the memory.

In addition, the information on programs for achieving each function, tables, files and the like may be stored in a computer-readable recording medium such as a HDD, an SSD, a USB memory, a CD-ROM, a DVD-ROM (Digital versatile disk read only memory), an MO (Magneto-optical disk), an IC (Integrated Circuit) card, and an SD memory card, or may be provided through a network.

Storage section 3 is a storage medium that stores a variety of information used in terminal 2, and is composed of a hard disk or a memory. For example, storage section 3 stores a program for controlling transaction data generation section 5 and the like.

Control section 4 generally controls the operation of terminal 2. For example, control section 4 controls the operation of each of storage section 3, transaction data generation section 5, blockchain processing section 6, execution section 7, and communication section 8. Control section 4 can implement a part of transaction data generation section 5, blockchain processing section 6, execution section 7, and communication section 8, for example.

As described above, in the platooning assistance device according to the present embodiment, each of a plurality of vehicles 1 making up a platoon includes: transaction data generation section 5 configured to generate, as transaction data, a platoon ID, a vehicle ID, and a fuel consumption amount of a platooning vehicle, and communication section 8 configured to transmit, to a blockchain network, the transaction data generated, and receive, from the blockchain network, the transaction data of each of the plurality of vehicles that is approved by a function of a blockchain. One of the plurality of vehicles 1 includes: storage section 3 configured to store smart contract data in which a predetermined process of distributing the effect of platooning and making a payment is programed, and execution section 7 configured to execute the predetermined process based on the approved data in the blockchain.

With the above-described configuration, the predetermined process of distributing the effect of platooning and making a payment is executed in the blockchain, and thus it is possible to distribute the effect of platooning and make a payment for each of the plurality of vehicles 1 making up the platoon. In addition, since a dedicated server for performing payment agency service and the like are unnecessary, the platooning assistance device can be operated at low cost with no cost such as the equipment cost for the communication between the dedicated server and the in-vehicle terminal, and the server maintenance cost. In this manner, the feasibility of distributing the effect of platooning and making a payment can be increased.

In addition, in the present embodiment, the effect of platooning is a gain corresponding to a difference between an actual value of a fuel consumption amount of each of the plurality of vehicles 1 making up the platoon and an average value of the fuel consumption amount. In this manner, the gain can be easily calculated by multiplying the difference as the fuel consumption amount by a predetermined unit price. In turn, as the effect of platooning, the calculated gain can be easily and accurately distributed to each of the plurality of vehicles 1 and a payment can be performed.

In addition, in the present embodiment, the effect of platooning is a gain corresponding to a difference between an actual value of a fuel consumption amount of each of the plurality of vehicles 1 making up the platoon and an estimation value of a fuel consumption amount of a vehicle that is estimated when the platooning is not performed. In this manner, the gain can be easily calculated by multiplying the difference as the fuel consumption amount by a predetermined unit price. In turn, as the effect of platooning, the calculated gain can be easily and accurately distributed to each of the plurality of vehicles 1 and a payment can be performed.

In addition, in the present embodiment, when the platooning is completed, execution section 7 executes a predetermined process of distributing the effect of platooning and making a payment. In this manner, execution section 7 can automatically and timely start the payment process.

The present disclosure is not limited to the present embodiment. For example, execution section 7 may execute a predetermined process at a predetermined time interval during the platooning. In this manner, the user can recognize a change of the effect of platooning (such as the difference and the gain) during platooning. In turn, the payment can be estimated.

In addition, the present disclosure is not limited to the present embodiment. For example, execution section 7 may execute a predetermined process on a predetermined date. For example, in the case where a platoon is composed of a plurality of vehicles 1 managed by the same business operator, and there is not much need to make a payment for each platooning, a predetermined process can be performed on a predetermined date in a collective manner.

In addition, in the present embodiment, the fuel consumption improvement effect is mentioned as the effect of platooning, and the CO2 emission amount reduction effect is not mentioned. However, the emission amount reduction effect as the effect of platooning can replace the fuel consumption improvement effect, and both the emission amount reduction effect and the fuel consumption improvement effect can be included as the effect of platooning. Note that the emission amount reduction effect is the gain corresponding to the difference between the actual value of the emission amount of each of a plurality of vehicles 1 making up a platoon and the average value of each emission amount. In addition, the emission amount reduction effect may be a gain corresponding to the difference between the actual value of the emission amount of each of a plurality of vehicles 1 making up a platoon and an estimation value of the emission amount of the vehicle estimated in a non-platooning case. The gain can be calculated by multiplying their difference by a predetermined amount.

### Modifications

In addition, while execution section 7 executes a predetermined process in the blockchain on the basis of the approval data in the above-described platooning assistance device according to the embodiment, the present disclosure is not limited to this. It may take a longer time than expected from the transmission of the transaction data of each of the plurality of vehicles 1 to the blockchain network to the reception of the approval data from the blockchain network. In addition, there is a need to quickly perform the payment process. In view of this, more specifically, control section 4 may execute a provisional payment process on the basis of unapproved data. Here, the “unapproved data” is transaction data of each of the plurality of vehicles 1, and is data that is not verified or approved by blockchain processing section 6 of each of the plurality of vehicles 1, and/or the approval terminal (mining device).

Control section 4 executes a provisional payment process (a process of distributing the effect of platooning and making a payment) on the basis of unapproved data, and outputs provisional payment data. The provisional payment data is transmitted to the network (or a blockchain network). In this manner, communication section 8 of each of the plurality of vehicles 1 receives the provisional payment data from the network. On the other hand, execution section 7 executes the main payment process on the basis of the approval data. This main payment process corresponds to the predetermined process illustrated at step S140 in FIG. 2. For example, execution section 7 executes the main payment process on a predetermined date (for example, a main payment date). Note that the predetermined main payment date is stored in storage section 3.

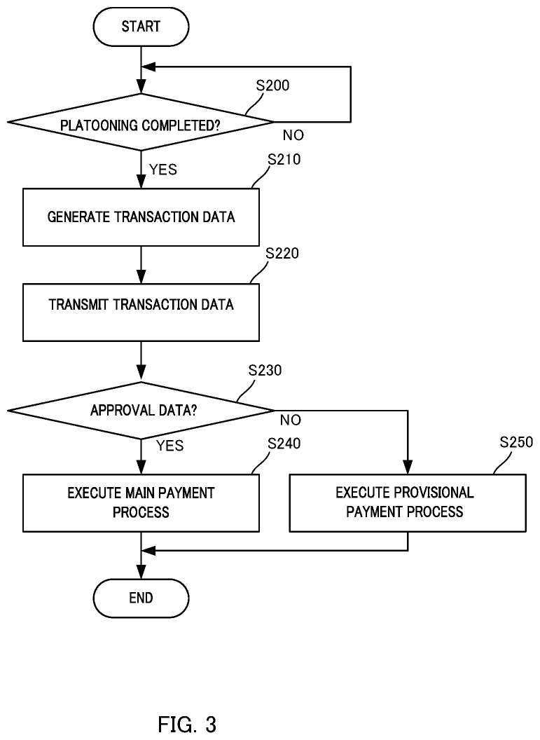

The above-described provisional payment process is described with reference to FIG. 3 as a modification of the present embodiment. FIG. 3 is a flowchart illustrating an operation of a platooning assistance device according to the modification. In the description of the modification, steps S100, S110 and S120 of the flowchart illustrated in FIG. 2 correspond to steps S200, S210 and S220 of the flowchart illustrated in FIG. 3, and therefore the description thereof is omitted. The following description starts from step S230 in FIG. 3.

At step S230 in FIG. 3, control section 4 determines whether the transaction data is approval data. When the transaction data is approval data (step S230: YES), the process is advanced to step S240. When the transaction data is unapproved data (step S230: NO), the process is advanced to step S250.

At step S240, execution section 7 executes the main payment process (the same process as that of step S140 in FIG. 2). Then, the procedure illustrated in FIG. 3 is completed. Next, at step S250, control section 4 executes the provisional payment process. In the provisional payment process, a process that uses the unapproved data to distribute the effect of platooning and make a payment is performed. Thereafter, the procedure illustrated in FIG. 3 is completed.

In the above-described modification, the process that uses the unapproved data to make a payment can be performed, and it is not necessary to wait for the main payment process (at step S240 in FIG. 3) until communication section 8 receives the approval data, and thus the provisional payment can be quickly performed.

The above-described embodiments are merely examples of embodiments for implementing the disclosure, and the technical scope of the disclosure should not be interpreted as limited by them. In other words, the present disclosure can be implemented in various forms without deviating from its gist or main features.

This application is entitled to and claims the benefit of Japanese Patent Application No. 2021-047195 filed on Mar. 22, 2021, the disclosure each of which including the specification, drawings and abstract is incorporated herein by reference in its entirety.

### INDUSTRIAL APPLICABILITY

The present disclosure is favorably utilized for a vehicle including a platooning assistance device that is required to distribute the effect of platooning and make a payment.

### REFERENCE SIGNS LIST

1 Vehicle
1A Leading vehicle
1B Intermediate vehicle
1C Last vehicle
2 Terminal
3 Storage section
4 Control section
5 Transaction data generation section
6 Blockchain processing section
7 Execution section
8 Communication section

1. A platooning assistance device,
wherein each of a plurality of vehicles making up a platoon includes:
a transaction data generation section configured to generate, as transaction data, platoon identification information for identifying the platoon, vehicle identification information for identifying the vehicle, and a fuel consumption amount of a platooning vehicle, and
a communication section configured to transmit, to a network, the transaction data generated, and receive, from the network, the transaction data of each of the plurality of vehicles that is approved by a function of a blockchain, and
wherein one of the plurality of vehicles includes:
a storage section configured to store smart contract data in which a predetermined process of distributing an effect of platooning and making a payment is programed, and
an execution section configured to execute the predetermined process based on the approved data in the blockchain.

2. The platooning assistance device according to claim 1, wherein the effect of platooning is a gain corresponding to a difference between an actual value of a fuel consumption amount of each of the plurality of vehicles and an average value of the fuel consumption amount of each of the plurality of vehicles.

3. The platooning assistance device according to claim 1, wherein the effect of platooning is a gain corresponding to a difference between an actual value of a fuel consumption amount of each of the plurality of vehicles and an estimation value of a fuel consumption amount of a vehicle that is estimated when platooning is not performed.

4. The platooning assistance device according to claim 1, wherein when the platooning is completed, the execution section executes the predetermined process.

5. The platooning assistance device according to claim 1, wherein the execution section executes the predetermined process at a predetermined time interval during the platooning.

6. The platooning assistance device according to claim 1, wherein the execution section executes the predetermined process on a predetermined date.

7. A platooning assistance method,
wherein a terminal of each of a plurality of vehicles making up a platoon
generates, as transaction data, platoon identification information for identifying the platoon, vehicle identification information for identifying the vehicle, and a fuel consumption amount of a platooning vehicle, and
transmits, to a network, the transaction data generated, and receives, from the network, the transaction data of each of the plurality of vehicles that is approved by a function of a blockchain, and
wherein the terminal of one of the plurality of vehicles
stores smart contract data in which a predetermined process of distributing an effect of platooning and making a payment is programed, and
executes the predetermined process based on the approved data in the blockchain.

8. A program configured to cause a computer of each of a plurality of vehicles making up a platoon to perform a process of
generating, as transaction data, platoon identification information for identifying the platoon, vehicle identification information for identifying the vehicle, and a fuel consumption amount of a platooning vehicle,
transmitting, to a network, the transaction data generated, and
receiving, from the network, the transaction data of each of the plurality of vehicles that is approved by a function of a blockchain,
the program being configured to cause the computer of one of the plurality of vehicles to execute a process of distributing an effect of platooning and making a payment based on the approved data in the blockchain.
